(19) United States
(12) Patent Application Publication
(10) Pub. No.: US 2016/0294133 A1
(43) Pub. Date: Oct. 6, 2016

(54) PLUG WITH INTEGRATED SELF-REPLICATED SOCKET

(71) Applicant: Gang Xie, Los Alamos, NM (US)

(72) Inventor: Gang Xie, Los Alamos, NM (US)

(21) Appl. No.: 14/672,231

(22) Filed: Mar. 30, 2015

(51) Int. Cl. H01R 27/02; H01R 13/70

(52) U.S. Cl. CPC H01R 27/02; H01R 13/70

(57) ABSTRACT

An improved electric plug is disclosed having an extra extension cord sticking out of one side and a socket disposed at another end of the plug body so as to permit another plug to be coupled thereto consecutively. In particular, the present invention relates to electrical cable and/or communication cable that terminate in a modular interconnection housing that can be used as charging cable and data cable for a smart phone, and tablet, or something like. A build-in switch can shift its function between Power Sharing and Data Sharing mode. The modular interconnection housings from standard cable style design and keychain style design have a male communication connector protruding from one end, and a female communication connector received at another end or at another attached cable. The male communication connector is designed to provide electrical communication or power through various USB, thunderbolt, lightning cables, but not limited to these cables.

### CROSS REFERENCE TO RELATED APPLICATION

This application claims priority to U.S. Provisional Patent Application 61/972,224 filed on Mar. 29, 2014, the contents of which are incorporated herein by reference.

### FIELD OF THE INVENTION

The present invention relates generally to the field of connectivity devices, including cables used to connect with devices as a part of phone accessories, and computing accessories, and other peripherals.

### BACKGROUND OF THE INVENTION

Handheld and/or portable electronic devices (e.g., digital media players, phones, smartphones, tablet computers, handheld readers, and similar devices) are becoming important and common tools. These tools are constantly in use, both at home and on the go. Additionally, mobile communication devices, such as smart phones, have become increasingly powerful and compact. Due to this decrease in size and increasing functionality, many people prefer to carry their mobile communication devices as their only multiple functional device on their person or accessories. With the fast development of electric accessories widely used daily, such as smart phone, e-reader, table, Bluetooth earphone, smart watch and objects of the like, charging these devices daily is required. Frequently, users experienced not having enough charging outlet if all devices charged at the same time. It is especially true while on travel, such as in vehicle, on airplane, at airport, and in hotel room, typically, the single or limited power outlets are not quite enough to meet the requirement any more. It's also especially true for laptop users: there just aren't enough USB ports to accommodate all of the chargers, dongles and cables that a modern, connected lifestyle needs to take into account. For example: MacBook air and Macbook pro have one and two USB ports respectively, new Macbook only has one USB-C port. It's a common problem for laptop to use multiple devices at the same time, such as USB mouse, external hard drive, USB flash drive, webcam etc, as well as other devices connected by USB-C thunderbolt, lightning, eSTAT, firewire 1394 cables. With our on the go lives and reliance on our portable electronic devices, we can nearly be certain, we will never have enough USB port or find enough power outlet. For data transferring need, we have to always carry a multiple port USB hub for connecting multiple devices to our slimbook (Apple Air, MS Surface). The Multiple Port USB Hub is perfect for data transferring, but not designed to charge multiple devices. In addition, we have to always carry an AC adapter or external battery (Powerbank) for charging each mobile device. More recently, we can carry a multiple port charging station instead, which is perfect there is only one outlet available, but not data transferring capability and bulky size, preventing us traveling light. The Although the easy remedy these days is the USB hub, splitter, surge suppressor, we have come up a design of a plug with integrated self-replicated socket descripted in detail below to address the common limitation that is the lack of these ports in proportion to the number of devices we would like to hook up.

U.S. Pat. No. 5,326,283 describes an improved electric plug for automobile use is equipped with an extra extension cord sticking out of a side hole; and a cord fixing hook disposed at the periphery of the top end of the plug body; and a socket disposed at the top end of the plug body so as to permit another plug to be coupled thereto consecutively. The extension cord can be adjustably wound around the plug body with the cord retained by the cord fixing hook, permitting the length of the cord to be varied to meet different requirement in use.

This design is limited to its usage for power charging electronic devices in automobile use only. It didn't address the need for data transferring purpose in a broad setting.

U.S. Pat. No. 7,537,490 describes a device for sharing signals from a portable media player is disclosed. The device includes a headset, a media player connector, a cable connected to the headset and the media player connector, and a breakaway connector connected to the device for sharing signals.

This design is limited to its usage for audio sharing from a portable media players only. It didn't address the need for power charging and data transferring purpose in a broad setting.

U.S. Pat. No. 6,600,826 describes an audio headphone that is disclosed having a pair of earpiece speakers affixed to an adjustable leaf spring such as to allow the headphone to affix to a user's head in such a manner as to align the speakers with the user's ears. The speakers are in electrical communication with a stereo, CD player, MP-3 player, or the like by a communication cable that terminates in a modular interconnection housing. The modular interconnection housing has a male communication connector protruding from one end, and a female communication connector received at the opposite end. The male communication connector is designed to provide electrical communication with the audio signal, and the female communication connector is designed to provide parallel electrical communication with the male communication connector.

This design is limited to its usage for an audio headphone for sharing audio from the same media sources only. It didn't address the need for power charging and data transferring purpose in a broad setting.

U.S. Pat. No. 5,812,683 describes a headphone jack extended outlet which amplifies and splits the output signal from a single conventional headphone jack to power multiple headphone jacks. The extended outlet includes a conventional headphone plug that inserts directly into the headphone jack of a sound system and includes multiple headphone jacks for powering multiple headsets. The extended outlet further includes circuitry which amplifies the output signal received from the sound system to a level sufficient to power multiple headsets.

This design is limited to its usage for audio sharing from an audio source only. It didn't address the need for power charging and data transferring purpose in a broad setting.

U.S. Pat. No. 6,929,514 describes a socket with non-connecting terminal comprises a socket body, two power terminals, a bottom cover, a support, a ground terminal and a top cover in which the power terminals and the ground prong are integrally stamped without terminal tap. The power terminals are placed in the first receptacle and the second receptacle and sealed with the support and the bottom cover. The power blades are exposed outside to be connected to the wall socket. The three slots serve as a power supply to receive other plugs. The integrally stamped ground terminal is housed in the support and sealed by the top cover; the ground prong is exposed outside for linking to the power supply. The three ground slots on the ground terminal will accept the ground prongs from other plugs. When an electrical current flows through this circuit, there is no resistance encountered and no heat generated.

This design is limited to its usage for expanding additional power terminal use only. It didn't address the need for data transferring purpose in a broad setting.

### BRIEF SUMMARY OF THE INVENTION

The present invention provides an improved electric/data plug that has an extra extension cord sticking out of one side and a socket disposed at another end of the plug body so as to permit another plug to be coupled thereto consecutively. More particularly this plug with integrated self-replicated socket is part of new modularly expandable cable construction enabled multi-device connected.

The general modularly expandable cable with a plug and integrated self-replicated socket of the present invention, which will be described subsequently in greater detail, is to provide a allows a plurality of devices to acquire the same data communication and/or power supply from a single output means in such a manner as to allow each device to make the same connection which has many of the advantages of the mobile devices mentioned heretofore and many novel features that result in a new modularly expandable, which is not anticipated, rendered obvious, suggested, or even implied by any of the prior art cables, either alone or in any combination thereof. Similar products are multiple port USB hub and USB charging station, not a property of the cable itself. In addition, related products focus on either data transfer or battery charging and all have its limitations.

The modular interconnection housing has a male communication connector protruding from one end, and a female communication connector received at the opposite end. The male communication connector is designed to provide data communication or power supply, and the female communication connector is designed to provide parallel data communication or power supply with the male communication connector. In this manner, more than one device can obtain the same communication output signal or power supply.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings of 3 different designs. The invention is capable of other embodiments and of being practiced and carried out in various ways. In addition, it is to be understood that the phraseology and terminology employed herein are for the modularly expandable, multi-devices connected cable of description and should not be regarded as limiting.

As such, those skilled in the art will appreciate that the conception, upon which this disclosure is based, may readily be utilized as a basis for the designing of other structures, methods and systems for carrying out the several modularly expandable cables of the present invention. It is important, therefore, that the claims be regarded as including such equivalent constructions insofar as they do not depart from the spirit and scope of the present invention.

Further, the modularly expandable cable with a plug and integrated self-replicated socket of the foregoing abstract is to enable the U.S. Patent and Trademark Office and the public generally, and especially the scientists, engineers and practitioners in the art who are not familiar with patent or legal terms of phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new modularly expandable apparatus and method which has many of the advantages mentioned heretofore and many novel features that result in a new modularly expandable cable enabling multi-devices connected which is not anticipated, rendered obvious, suggested, or even implied by any of the prior art cables, either alone or in any combination thereof.

It is another object of the present invention to provide a USB plug with integrated self-replicated socket that provides not only a connector for charging one device from an extra extension cord sticking out of one side, but also provides an additional USB dedicated port as a mini USB hub, due to build-in standard USB 2-port HUB. This allows cables to be stacked so that several devices can be charged and data communicated from a single USB port.

It is a further object of object of the present invention to provide this dual function of USB hub and USB charging connector that is packed in a small footprint design. For examples: A standard cable style design has a female USB socket disposed at another attached cord sticking out of one end of the plug body.

It is a still further object of object of the present invention to provide this dual function of USB hub and USB charging connector that is packed in a lightweight, compact and easy carrying around design. For examples: A keychain style design has a female USB socket directly facing to the male USB plug to save the space of the plug body.

It is a still further object of object of the present invention to provide not only a connector for charging your device, but also additional ports of USB hub. A build-in switch can shift its function between 2 modes: 1) Power Sharing mode of bypassing USB hub chip and serve for charging purpose as a power splitter, and 2) Data Sharing mode of passing USB hub chip and serve for data communication purpose.

It is another object of the present invention to provide a new modularly expandable cable with a plug and integrated self-replicated socket which may be easily and efficiently manufactured and marketed.

It is a further object of the present invention to provide a new modularly expandable, multi-devices connected cable which is of a durable and reliable construction.

An even further object of the present invention is to provide a new modularly expandable cable that is susceptible of a low cost of manufacture with regard to both materials and labor, and which accordingly is then susceptible of low prices of sale to the consuming public, thereby making such modularly expandable cable economically available to the buying public.

Still yet another object of the present invention is to provide a new modularly expandable cable which provides in the apparatuses and methods of the prior art some of the advantages thereof, while simultaneously overcoming some of the disadvantages normally associated therewith.

Still another object of the present invention is to provide a new modularly expandable cable with a plug and integrated self-replicated socket for allowing a plurality of devices to acquire the same communication data and power supply from output means.

Yet another object of the present invention is to provide a new modularly expandable cable which includes a plurality of devices to acquire the same communication signal or power from output means in a manner such that each individual device can work independently.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a diagram showing the structure of the present invention, a new modularly expandable cable with a plug and integrated self-replicated socket according to the present invention.

FIG. 2 is a diagram showing two plugs of the present invention being associated with each other end to end.

FIG. 3 is a diagram showing the structure of the present invention in standard cable style design

FIG. 4 is a diagram showing the structure of the present invention in keychain style design

FIG. 5 is a diagram showing two plugs of the present invention in keychain style design being associated with each other end to end.

FIG. 6 is a diagram showing two stacked plugs of the present invention in keychain style design being associated with up to 3 mobile devices.

FIG. 7 is an electrical schematic of the switch in present invention.

### DESCRIPTION OF THE PREFERRED EMBODIMENT

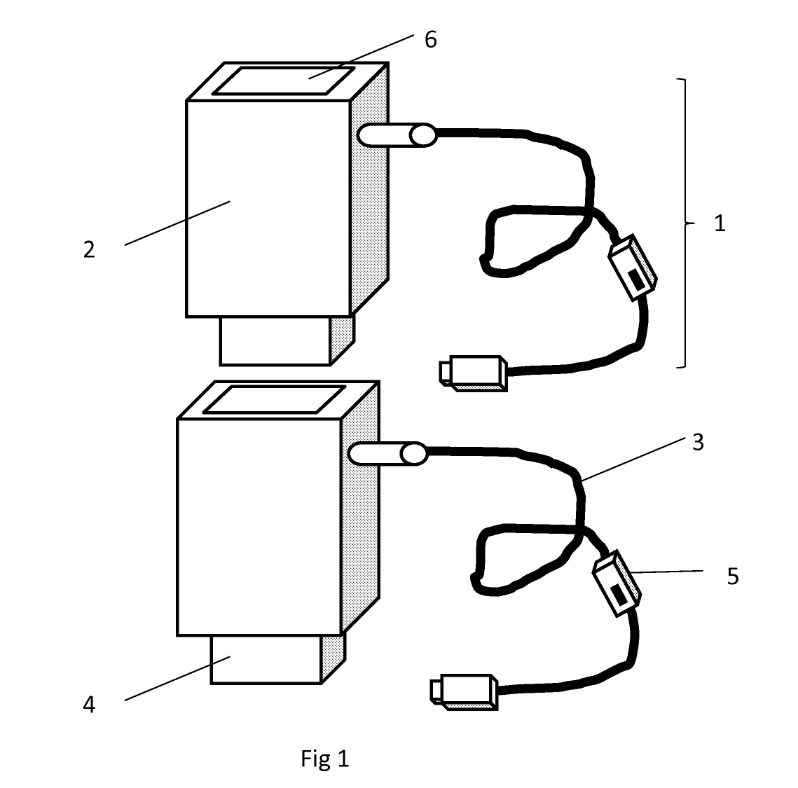

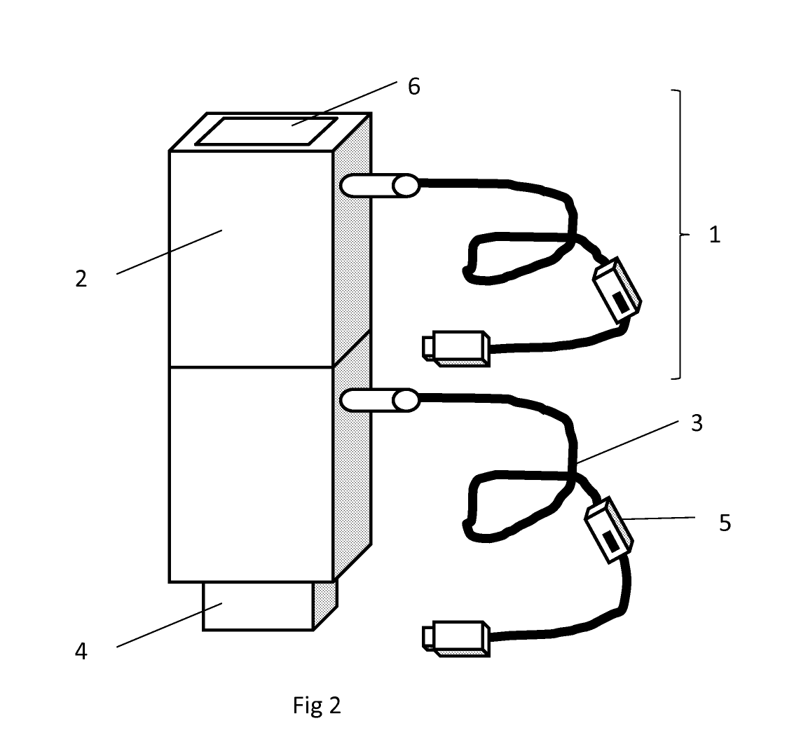

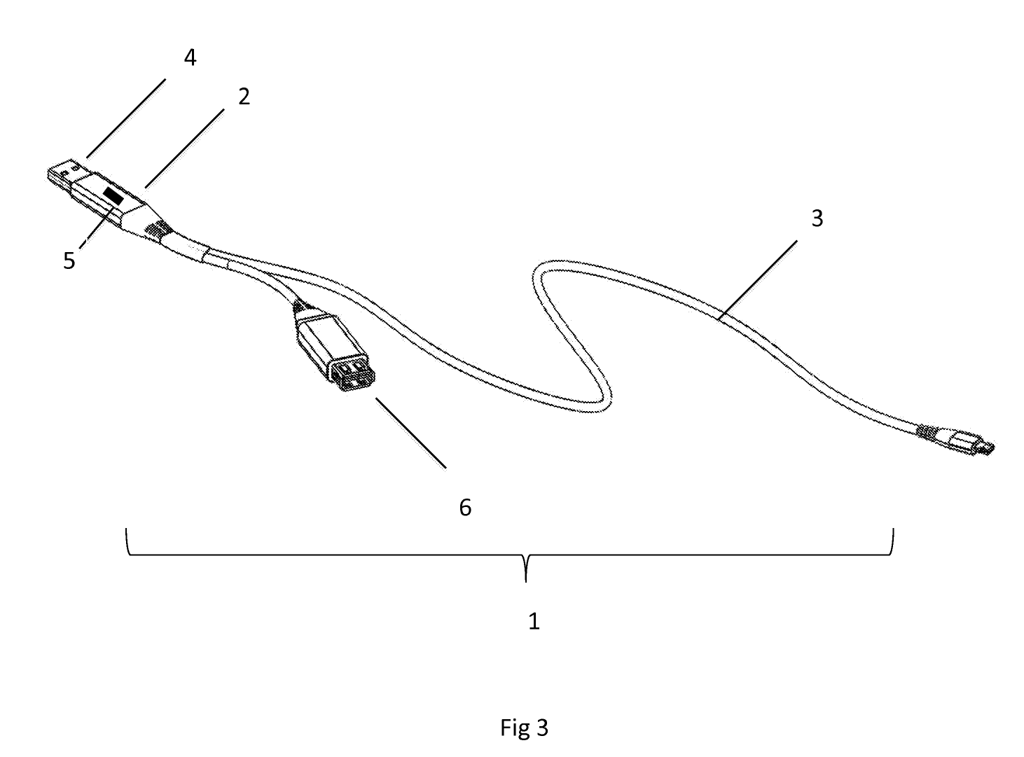

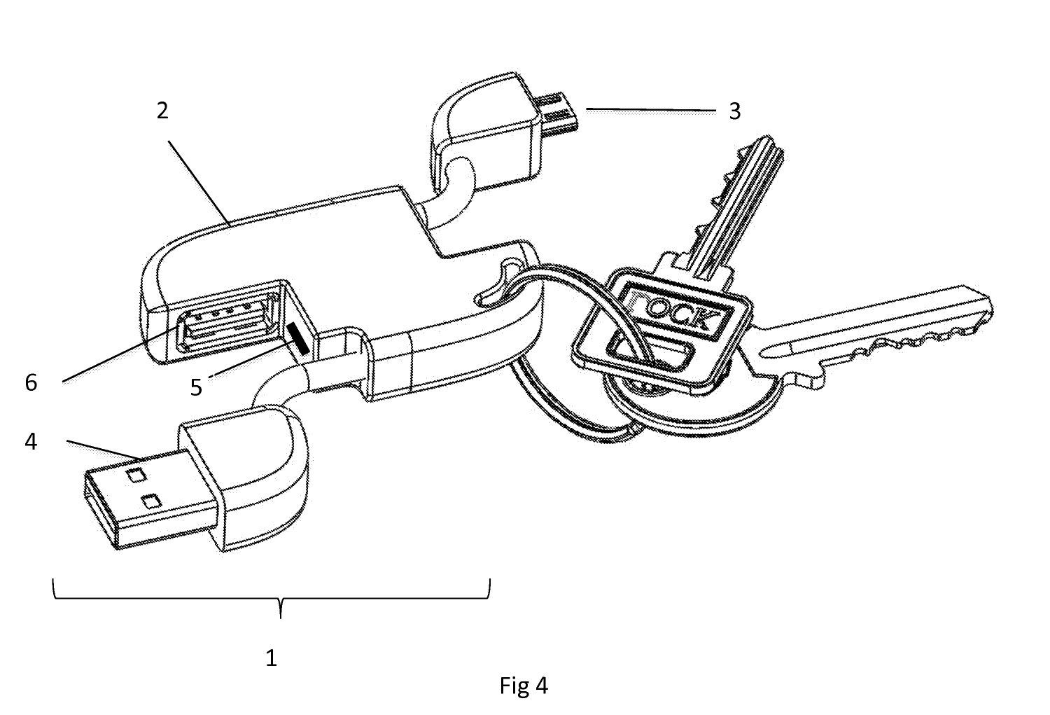

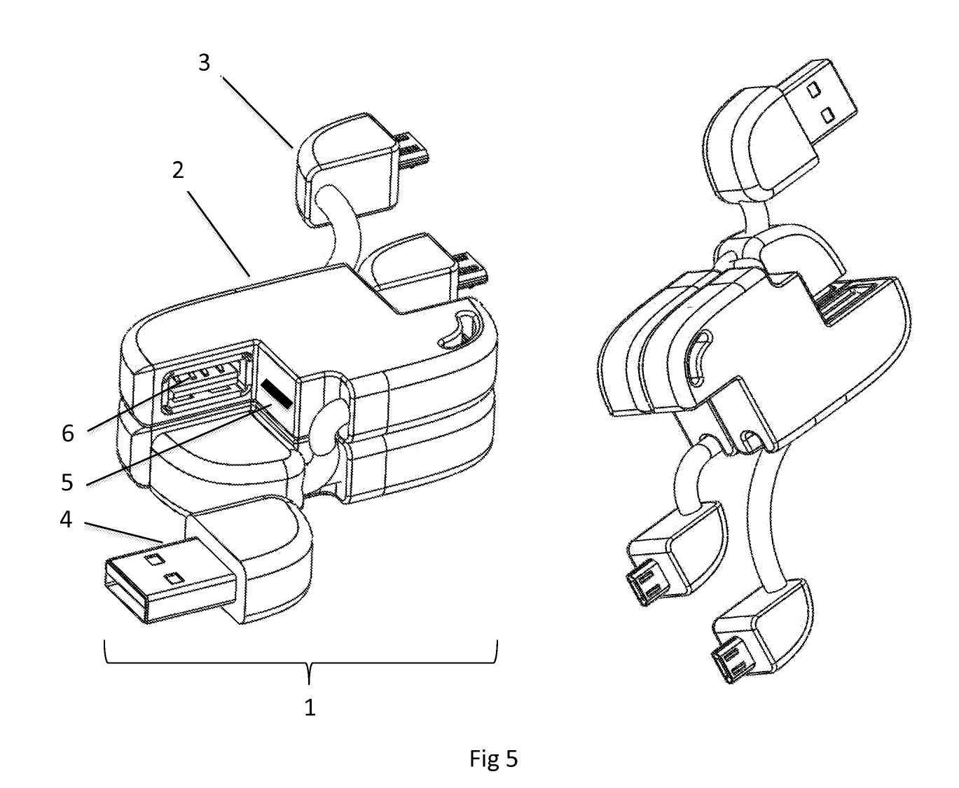

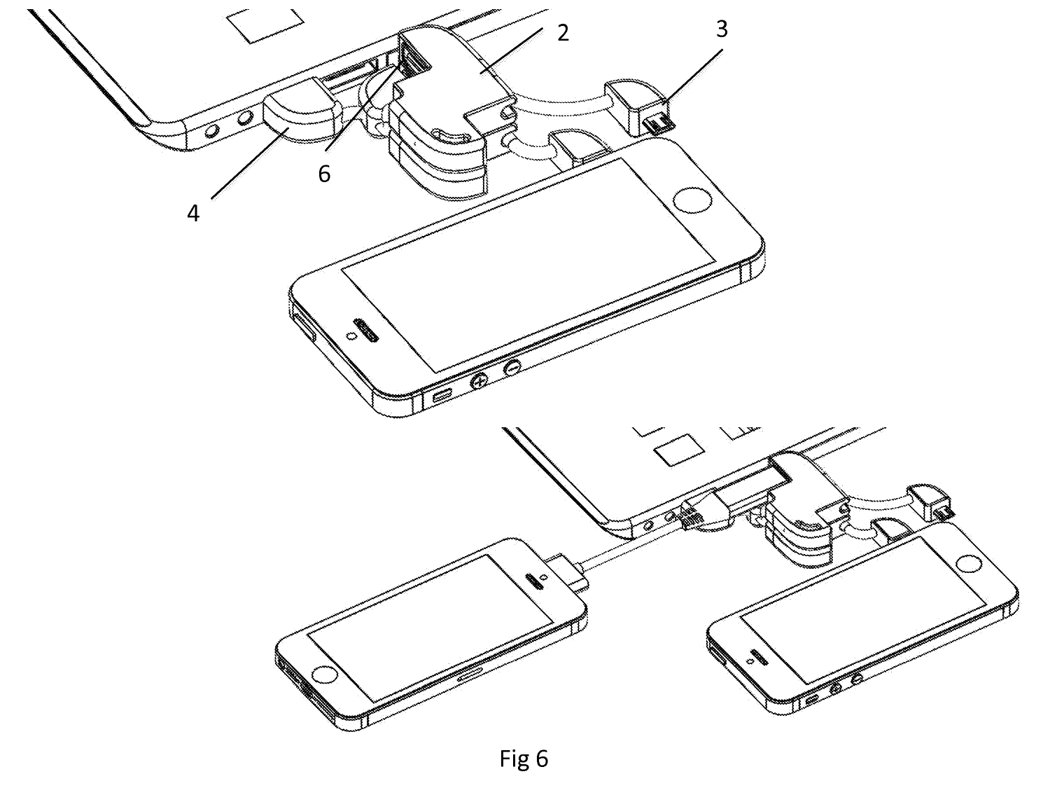

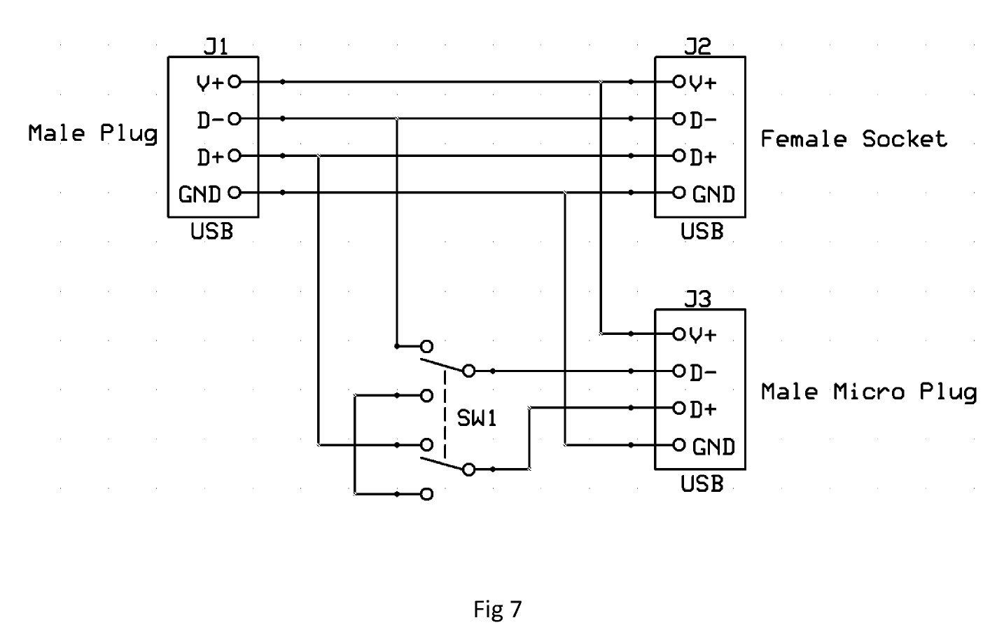

With reference now to the drawings, and in particular to FIGS. 1 through 7 thereof, a new modularly expandable cable with a plug and integrated self-replicated socket embodying the principles and concepts of the present invention and generally designated by the reference numeral 1 will be described. FIGS. 3 and 4 are diagrams showing the structure of the present invention in standard cable style design and keychain style design respectively.

As best illustrated in FIGS. 1 through 7, a pair of modularly expandable, cables with a plug and integrated self-replicated 1 are shown, each generally comprises modular interconnection housing 2 formed in a generally plug manner and having a top end opposite a bottom end. Protruding from the bottom end is a male communication connector 4. Although the advantages and benefits of the present invention can be achieved in conjunction with the use of any conventional type of electrical communication connector, by way of example, and not by limitation, shown herein is the use of a male communication connector 4. Suitably, the male communication connector may be formed a male plug known to those skilled in the art. Formed integrally within the housing 2 and extending inward from the top end is a female communication connector 6. Although the advantages and benefits of the present invention can be achieved in conjunction with the use of any conventional type of electrical communication connector, it is envisioned that the female communication connector 6 is designed and adapted to provide both firm mechanical contact to and integral electrical communication with a second male communication connector 4 from a second such as USB, thunderbolt, lightning, eSTAT, firewire 1394 cable, audio cable, and cigarette lighting plug for automobile. The male communication connector 4 is designed to provide electrical communication with the signal from data or power supply output means, anticipated as being any conventional, generally available appliance such as computer, mobile device, power adaptor, stereo, radio, cassette tape player, MP-3 player, or the like having signal or power output means connector, shown herein by way of example as a USB, thunderbolt, lightning, eSTAT, firewire 1394 cable, audio cable, and cigarette lighting plug connector. The female communication connector 6 is designed to provide parallel electrical communication with the male communication connector 4. In this manner, more than one device can obtain the same output signal or power supply.

Further, the male communication connector 4 is in electrical communication with, and provides an electrical signal or power to a cable 3. The cable 3, in turn, is in electrical communication with, and provides an electrical signal to a device, such as mobile phone, hard drive, smart phone, mouse, and GPS means. Although the advantages and benefits of the present invention can be provided in conjunction with any conventionally available mobile device means, for purposes of describing a best mode, and not by way of limitation, shown herein as a micro USB or USB-C cable means is a charging cable or data communication cable.

Additionally, within the housing or the communication cable 3 is a switch means 5 for controlling the transmission characteristics of the data signal or power transmitted through the cable 3. In this respect, it is envisioned that the switch means 5 could provide the ability to control either data sharing or power sharing mode of the signal transmitted between the signal output means 2.

In use, male communication connector 4 is designed to provide electrical communication with the data signal or power supply, and the female communication connector is designed to provide parallel electrical communication with the male communication connector. In this manner, more than one device can obtain the same output signal.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. through 7. (canceled)

8. A modularly expandable, stackable plug body, which functions as a multi-user 2-port USB hub system, comprising:
a modular interconnection housing formed a keychain style design that has a circuit board inside with a switch electrically coupled to the circuit board;
two output connectors, wherein the female socket/output connector formed integrally from said plug body and an output connector said communication cable can be unplugged from plug body for providing an electrical or data signal from said modular stackable plug body to another device;
and one input connector said male USB connector opposite another end of female socket that is a output connector, wherein this male connector can be plug/unplugged from said another end of female socket/ output connector to reduce the size of plug body.

9. The modularly expandable, stackable plug body as claimed in claim 8, wherein said male input connector is adapted for providing electrical communication of the signal from a signal output to at least 2 other devices through the female socket/output connector and the communication cable that are adapted for providing the signal to one of a plurality of said additional devices.

10. The modularly expandable, stackable plug body as claimed in claim 8, wherein two plug bodies can form a stackable configuration, in which male input connector rom the top plug body unit inserting into said female socket/output connector at the bottom plug body unit for coupling said plurality of additional devices in series for providing the signal to the plurality of additional devices through communication cable that could be USB plug, USB-C, Apple lighting cable, or any kind of connector.

11. The modularly expandable, stackable plug body according to claim 8, further comprising a switch electrically coupled to the circuit board inside of the modular interconnection housing, which can shift between power sharing and data sharing modes: 1) Power Sharing mode of bypassing USB hub circuit board and serve for charging purpose as a power splitter, and 2) Data Sharing mode of passing USB hub circuit board and serve for data communication purpose; wherein the present invention with build-in USB hub function to provide two output connectors not only for charging devices, but also for data sharing.
